(19) United States
(12) Patent Application Publication
(10) Pub. No.: US 2015/0138199 A1
(43) Pub. Date: May 21, 2015

(54) IMAGE GENERATING SYSTEM AND IMAGE GENERATING PROGRAM PRODUCT

(71) Applicant: KABUSHIKI KAISHA TOSHIBA, Tokyo (JP)

(72) Inventors: Kaoru SUGITA, Iruma-shi (JP); Masahiro SEKINE, Tokyo-to (JP); Masashi NISHIYAMA, Kawasaki-shi (JP)

(21) Appl. No.: 14/317,815

(22) Filed: Jun. 27, 2014

(30) Foreign Application Priority Data
Nov. 20, 2013 (JP) 2013-239955

(51) Int. Cl. G06T 15/80; G06T 19/00; G06T 17/20

(52) U.S. Cl. CPC G06T 15/80; G06T 17/20; G06T 19/006; G06T 2215/16; G06T 2210/04
USPC 345/426

(57) ABSTRACT

According to one embodiment, an image generating system generates an image of a target object virtually disposed inside a target space. The system includes a storage unit, a calculating unit and a presentation unit. The storage unit stores target object data representing a three-dimensional configuration and an external appearance of the target object. The calculating unit generates a three-dimensional model of the target space, a lighting model indicating a lighting region of the target space, a shading image based on the target object data and the lighting model, and a synthesized image of the shading image and the three-dimensional model. The shading image represents shading appearing at the target object. The generating of the shading image is performed by a selection of the target object, an arrangement position of the target object, and a position of a viewpoint. The presentation unit presents the synthesized image.

### CROSS-REFERENCE TO RELATED APPLICATIONS

This application is based upon and claims the benefit of priority from Japanese Patent Application No. 2013-239955, filed on Nov. 20, 2013; the entire contents of which are incorporated herein by reference.

### FIELD

Embodiments described herein relate generally to an image generating system and an image generating program product.

### BACKGROUND

In recent years, augmented reality (AR) display technology has been developed to generate an image of a virtual object disposed in real space. By using such technology, for example, in the case where a piece of furniture is to be placed in a room, the scenery of the room in the state in which the furniture is placed can be predicted without actually installing the furniture. Thereby, the effects of the furniture on the interior of the room can be evaluated with high accuracy beforehand.

However, if an image is synthesized by simply using a photograph of the room as the background and using a CG (computer graphics) image of the furniture as the foreground, the shading of the furniture is different from the actual shading; and there are cases where the scenery cannot be predicted accurately.

### BRIEF DESCRIPTION OF THE DRAWINGS

FIG. 1 is a block diagram showing an image generating system according to a first embodiment;

FIG. 2 shows the image generating system according to the first embodiment;

FIG. 3 is a flowchart showing an image generation method according to the first embodiment;

FIGS. 4A to 4C show examples of wire frames;

FIG. 5 shows a method for imaging a target space of the first embodiment;

FIG. 6A is a perspective view showing a three-dimensional model; and FIG. 6B is a six-side view;

FIG. 7A is a perspective view showing a lighting model; and FIG. 7B is a six-side view;

FIG. 8 is an image view showing an image in which the three-dimensional model and a target object data are synthesized;

FIG. 9 is an image view showing an image in which a shading image and the target object data are synthesized;

FIG. 10 is a block diagram showing an image generating system according to a second embodiment;

FIG. 11 shows a method for imaging a target space of a third embodiment; and

FIG. 12 and FIG. 13 show a target space of a fifth embodiment.

### DETAILED DESCRIPTION

In general, according to one embodiment, an image generating system is configured to generate an image of a target object virtually disposed inside a target space. The system includes a storage unit, a calculating unit and a presentation unit. The storage unit is configured to store target object data. The target object data represents a three-dimensional configuration of the target object and an external appearance of the target object. The calculating unit is configured to generate a three-dimensional model of the target space, generate a lighting model indicating a lighting region of the target space, generate a shading image based on the target object data and the lighting model, and generate a synthesized image of the shading image and the three-dimensional model. The shading image represents shading appearing at the target object. The generating of the shading image is performed by a selection of the target object, an arrangement position of the target object, and a position of a viewpoint. The presentation unit is configured to present the synthesized image.

Embodiments of the invention will now be described with reference to the drawings.

### First Embodiment

First, a first embodiment will be described.

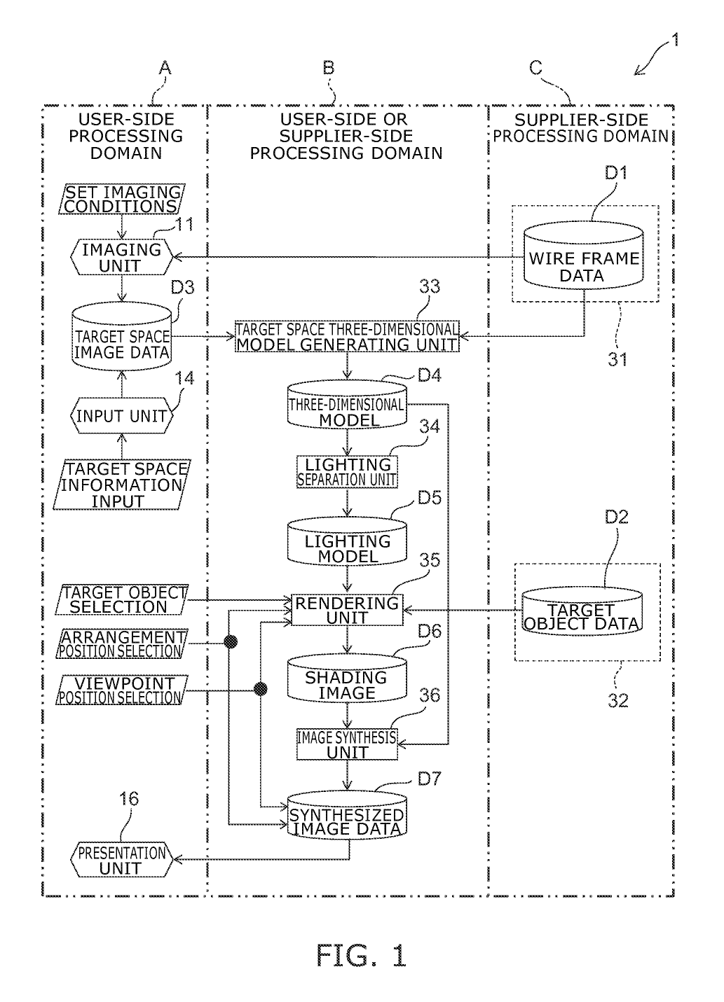

FIG. 1 is a block diagram showing an image generating system according to the embodiment.

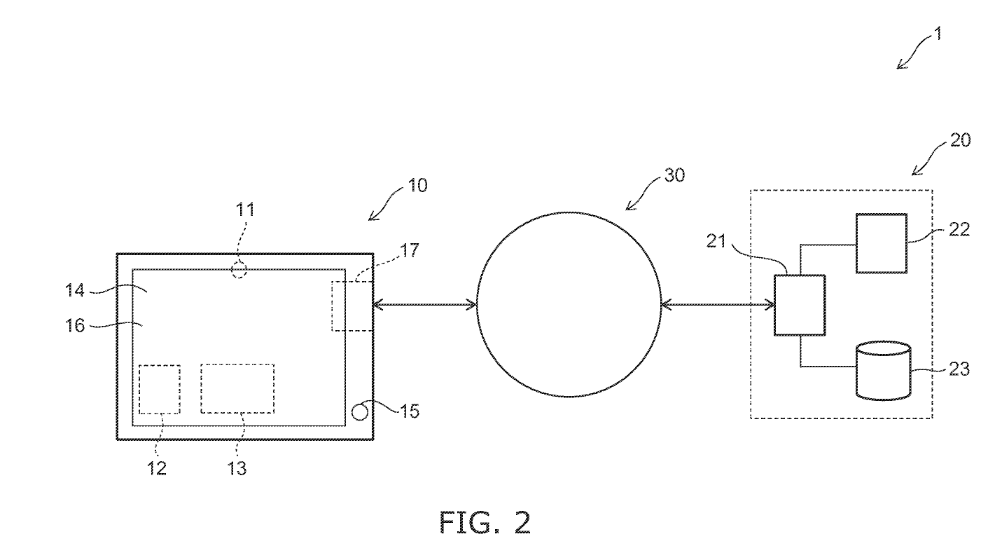

FIG. 2 shows the image generating system according to the embodiment.

The embodiment is an image generating system and an image generating program that generate an image of a target object virtually disposed inside a target space.

As shown in FIG. 1, a user-side processing domain A, a user-side or supplier-side processing domain B, and a supplier-side processing domain C are provided in the image generating system 1 according to the embodiment.

As an example in the embodiment, the case is assumed where a user is studying the purchase of furniture F from a supplier and the placement of the furniture F in a room R. In such a case, the room R is the target space; and the furniture F is the target object. The user is a general consumer studying the purchase of furniture; and the supplier is a vendor of furniture. The image generating system 1 is, for example, a system that generates an image of the furniture F to be purchased as being virtually disposed in the room R. The target space is not limited to a room and may be, for example, a large-scale facility such as a museum, a concert hall, etc., or an outdoor space in which lighting equipment is provided such as a sports arena, etc. The target object is not limited to furniture and may be, for example, an object other than furniture such as a household appliance product, a work of art, or the like that is placed fixedly or semi-fixedly inside the target space.

The user-side processing domain A shown in FIG. 1 includes processing that is executed and data that is stored by the system on the user side. The user-side system is a system in which an imaging unit, a calculating unit, a storage unit, an input unit, a presentation unit, and a communication unit are provided, e.g., a mobile terminal device in which these units are integrated into one body. The mobile terminal device is, for example, a smartphone, a tablet personal computer, a notebook-sized personal computer, an entertainment device, a household appliance, etc. An external device that is connected to the mobile terminal device may be included in the user-side system.

An example is described in the embodiment as shown in FIG. 2 in which the system on the user side includes a tablet personal computer (hereinbelow, called simply the “tablet”) 10. In the tablet 10, a camera 11 is provided as the imaging unit; a CPU (central processing unit) 12 is provided as the calculating unit; memory 13 is provided as the storage unit; a touch panel 14 and a mechanical button 15 are provided as the input unit; a display 16 is provided as the presentation unit; and a wireless LAN 17 is provided as the communication unit.

The touch panel 14, the mechanical button 15, and the display 16 are disposed on the front surface of the tablet 10; the camera 11 is disposed on the back surface of the tablet 10; and the CPU 12, the memory 13, and the wireless LAN 17 are contained in the interior of the tablet 10. For example, the touch panel 14 and the display 16 realize a software keyboard as the input unit.

The imaging unit is not limited to the camera 11 built into the tablet 10 and may be a separate digital camera or a camera fixed in the target space. The input unit is not limited to the touch panel 14 and the mechanical button 15 and may be an external hardware keyboard or a pointing device such as a mouse, etc. Necessary items may be input by a barcode being recognized by the camera 11. Also, the necessary items may be input by a sensor such as an acceleration sensor, etc. The presentation unit may be an external printing device or display device that is connected via wired communication or wireless communication. The presentation unit is not limited to the display 16 of the tablet 10 and may be another display of a personal computer, a separate television receiver, or a signage display placed in the shop of a supplier.

The supplier-side processing domain C includes processing that is executed and data that is stored by the system on the supplier side. The system on the supplier side is, for example, a computer facility 20 in possession of the supplier.

In the computer facility 20 as shown in FIG. 2, for example, a router 21 is provided as the communication unit; a CPU 22 is provided as the calculating unit; and a HDD (hard disk drive) 23 is provided as the storage unit. The supplier may possess multiple sets of computer facilities 20; and the computer facilities 20 may be placed in different locations and connected to each other by the Internet, etc.

A wire frame storage unit 31 and a target object data storage unit 32 are realized inside the HDD 23; wire frame data D1 is stored in the wire frame storage unit 31; and target object data D2 is stored in the target object data storage unit 32. The wire frame data D1 is data representing the wire frame used as the model of the configuration of the target space. The target object data D2 is CG data representing the three-dimensional configuration and external appearance of the target object.

The wire frame storage unit 31 may be realized inside the memory 13 which is a portion of the user-side system. For example, the configuration of the wire frame is a simple configuration such as a cube, a rectangular parallelepiped, etc.; and in the case where there are not many types of wire frames and the user matches the wire frame to the configuration of the room R by inputting parameters, the user may make the wire frame storage unit 31 inside his or her tablet 10 by pre-downloading the wire frame data D1 from the supplier-side system. Thereby, the user can set the wire frame with more degrees of freedom. On the other hand, for example, it is favorable for the wire frame storage unit 31 to be made in the HDD 23 which is a portion of the supplier-side system in the case where the supplier has prepared many types of wire frames, the data size of the wire frame data D1 is large, there are many degrees of freedom in the selection by the user, etc.

The tablet 10 is connectable to the computer facility 20 via a network 30. The network 30 may be the Internet, a mobile communication system, a wireless LAN, or a wired LAN. For example, in the case where the user connects to the computer facility 20 of the supplier from the user's home, the Internet or a mobile communication system may be used; and in the case where the user connects to the computer facility 20 by going to the shop of the supplier, a wireless LAN or a wired LAN located inside the shop may be used.

The user-side or supplier-side processing domain B includes processing and data that may be executed and stored by the system on the user side or executed and stored by the system on the supplier side. In other words, for the processing and data that belongs to the user-side or supplier-side processing domain B, all may be executed and stored by the system on the user side; all may be executed and stored by the system on the supplier side; or a portion may be executed and stored by the system on the user side and the remainder may be executed and stored by the system on the supplier side.

Operations of the image generating system according to the embodiment, i.e., an image generation method according to the embodiment, will now be described.

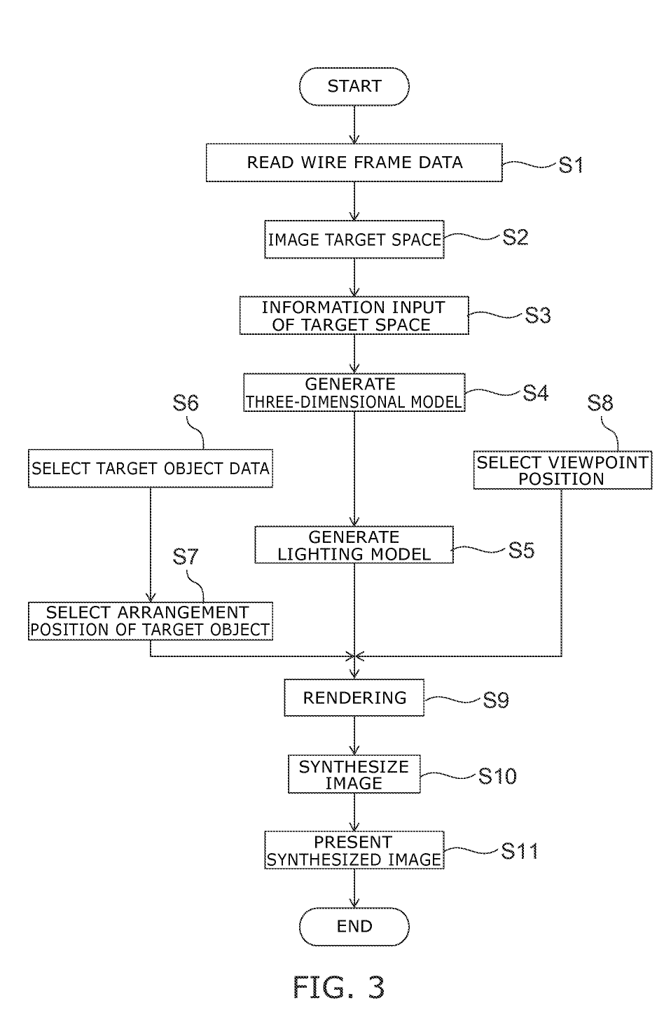

FIG. 3 is a flowchart showing the image generation method according to the embodiment.

As shown in FIG. 3, the image generation method according to the embodiment can be broadly divided summarily into the processes of generating the lighting model and the three-dimensional model of the target space (steps S1 to S5) and the processes of generating the shading image of the target object and generating the synthesized image of the target space and the target object (steps S6 to S11). The image generation method according to the embodiment will now be described in detail with reference to mainly FIG. 1 to FIG. 3.

As shown in step S1 of FIG. 3, the user reads the wire frame data D1 from the wire frame storage unit 31 realized inside the HDD 23 of the computer facility 20 via the network 30 by operating the tablet 10. The wire frame is a relatively simple three-dimensional shape that approximates the configuration of the target space. Multiple types of wire frame data are stored in the wire frame storage unit 31.

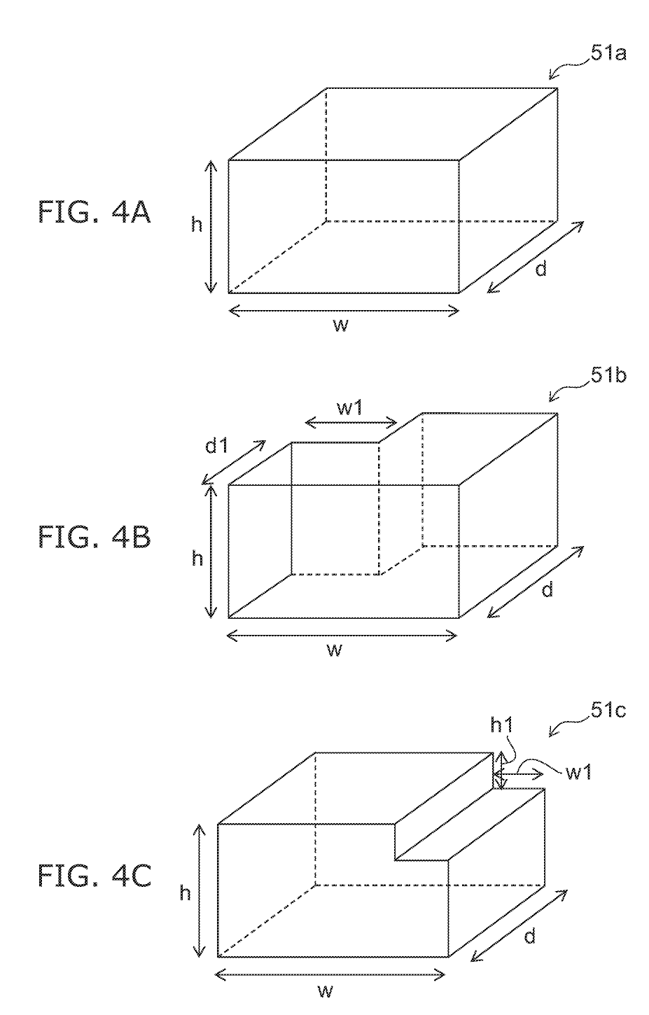

FIGS. 4A to 4C show examples of wire frames.

FIG. 4A shows a wire frame 51a of a rectangular parallelepiped; FIG. 4B shows a wire frame 51b that models a room having an L-shape; and FIG. 4C shows a wire frame 51c that models a room having a beam.

In the embodiment, for example, the wire frame 51a that is the rectangular parallelepiped is selected and read.

The configuration of the wire frame is not limited to the configurations shown in FIGS. 4A to 4C and may be appropriately set according to the configuration of the target space that is assumed. Further, the configuration of the wire frame is not limited to a configuration in which rectangular parallelepipeds are combined and may be any configuration having triangular polygons and/or curved surfaces as components. Also, the wire frame may be corrected after the target space is imaged.

Then, as shown in step S2 of FIG. 3, the user uses the camera 11 of the tablet 10 to image the room R which is the target space.

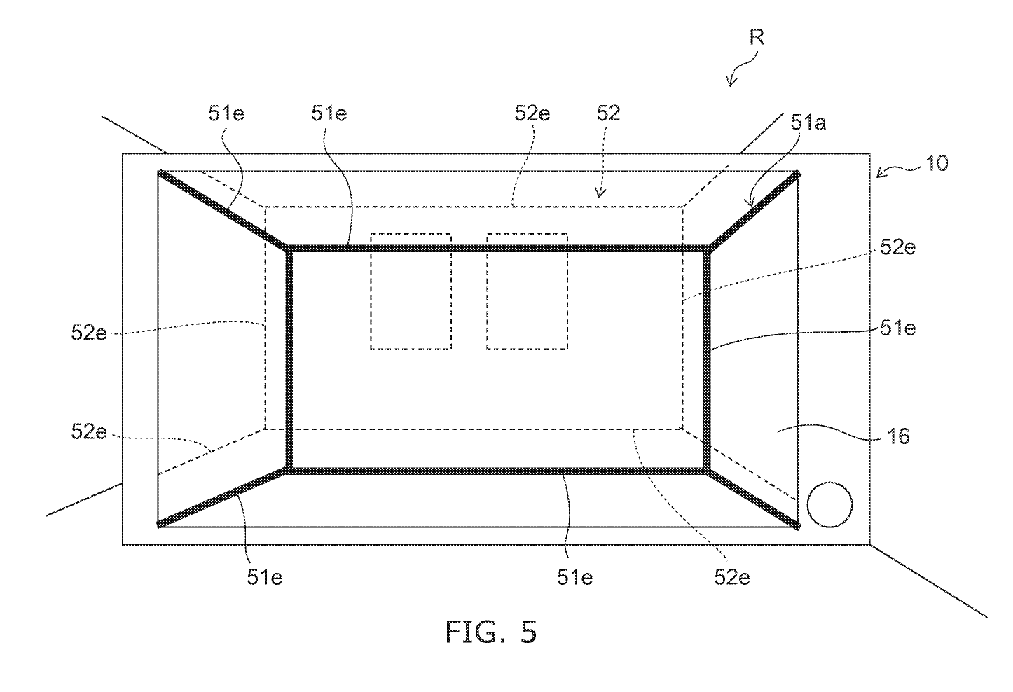

FIG. 5 shows a method for imaging the target space of the embodiment.

When imaging the room R as shown in FIG. 5, an image 52 of the room R is caused to correspond to the wire frame 51a on the display 16 by setting the imaging conditions such as the viewing angle, the imaging direction, etc.

Specifically, the image 52 that is formed by the camera 11 is displayed by the display 16; and sides 52e of the room R of the image 52 are caused to match sides 51e of the wire frame 51a. The sides 52e are, for example, the boundary lines between the ceiling and the walls, the boundary lines between the walls and the walls, and the boundary lines between the walls and the floor; and the sides 51e are wire portions of the wire frame 51a. At this time, the wire frame 51a may be enlarged, reduced, and rotated and the positions of the sides 51e may be modified by operating the touch panel 14 of the tablet 10. Or, the CPU 12 may detect the sides 52e by extracting the outlines included in the image 52 and adjusting the positions of the sides 51e to match those of the sides 52e. When the image 52 matches the wire frame 51a, the room R is imaged by storing the image 52 in the memory 13.

When imaging, it is favorable to perform wide dynamic range imaging by imaging multiple times using mutually-different exposures from the same viewpoint at the same viewing angle in the same direction and by synthesizing the multiple images. In the case where regions are detected where the luminance value is a constant value or more, imaging is performed by reducing the exposure parameters of the camera from the reference value until such regions have not more than a constant luminance value; and the brightness of each region is calculated by multiplying the luminance value of the captured image by the ratio of the actual exposure parameters and the reference value. Thereby, the luminance of the lighting regions can be estimated accurately when generating a lighting model D5 in subsequent processes.

Then, one target space is multiply imaged using different directions. For example, the room R is imaged in the six directions of north, south, east, west, up, and down. In the case where one surface of the room R cannot be covered by one imaging, the one surface is imaged multiple times. Thereby, the captured image 52 is caused to correspond to all inner surfaces of the wire frame. Thus, target space image data D3 is acquired. By using a wide angle lens or a fisheye lens, a wider region can be covered with one imaging; and the number of images taken can be reduced. Also, the imaging may be performed simultaneously from mutually-different directions by multiple cameras; or a wider region may be covered by one imaging by using an omni-directional camera.

Continuing as shown in step S3 of FIG. 3, information relating to the target space is input. For example, a width w, a depth d, and a height h of the wire frame 51a shown in FIG. 4A are input for the room R using the touch panel 14 or using both the touch panel 14 and the mechanical button 15. In the case where the wire frame 51b or 51c is selected as the wire frame, the dimensional parameters shown in FIG. 4B or FIG. 4C are input. At this time, appurtenant information of the target space also may be input. The appurtenant information includes, for example, positional information such as the address, etc., of the room R, the name of the room R, the imaging time and date, the weather when imaging, the open/close state of the curtains, the on/off-state of the lighting, etc.

In the case where an acceleration sensor, a magnetic compass, etc., are mounted in the tablet 10, the direction in which the camera 11 is oriented may be estimated based on such sensor information; and this result may be associated with the captured image and recorded. In the case where a GPS (Global Positioning System) function is mounted in the tablet 10, the positional information of the room R may be input based on the GPS information.

The order of step S2 (the imaging process) and step S3 (the input process) described above may be interchanged. For example, the information of the target space is input as shown in step S3 after the wire frame is read as shown in step S1. Subsequently, the user images the room R which is the target space using the camera 11 of the tablet 10 as shown in step S2. Thus, the wire frame becomes more accurate; and the work of matching the image is easy when the user images the room R. On the other hand, in the case where the proportions of the dimensions and/or the layout are substantially equal between the wire frame and the room R, little effort is required to accurately input the actual dimensions of the target space because the image of the room R that is imaged substantially matches the wire frame.

Then, as shown in step S4 of FIG. 3, a target space three-dimensional model generating unit 33 generates a three-dimensional model D4 of the target space by associating the captured image with the wire frame 51a based on the wire frame data D1, the target space image data D3, and the information of the target space input in step S3. Specifically, a region corresponding to the captured image is attached to each surface of the wire frame 51a. The three-dimensional model D4 is formed from, for example, a polygonal model which is a set of triangular meshes and textured images having a wide dynamic range format.

In the case where two or more captured images overlap an inner surface of the wire frame, the average luminance value may be used as the texture; the captured image having the newest imaging time and date may be used preferentially; or the captured image for which the angle between the imaging direction and the normal direction of the inner surface of the wire frame associated with the captured image is smallest may be used preferentially.

Then, as shown in step S5 of FIG. 3, a lighting separation unit 34 separates the lighting regions existing inside the target space by using the three-dimensional model D4. Thereby, the lighting model D5 that indicates the positions, sizes, and luminance of the lighting regions is generated. A target space model generating unit includes the target space three-dimensional model generating unit 33 and the lighting separation unit 34.

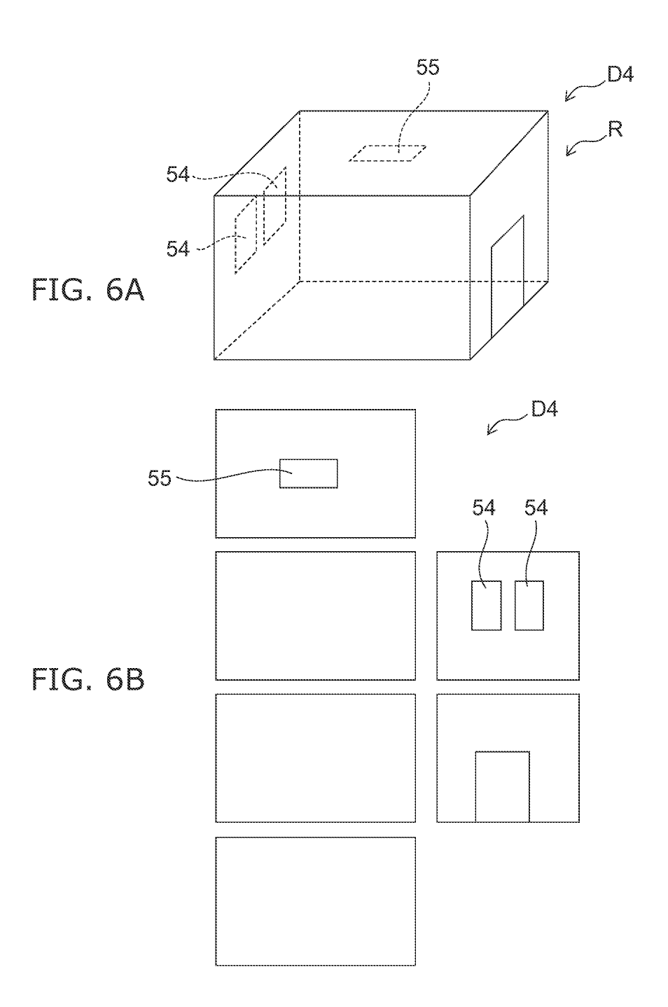

FIG. 6A is a perspective view showing the three-dimensional model; and FIG. 6B is a six-side view.

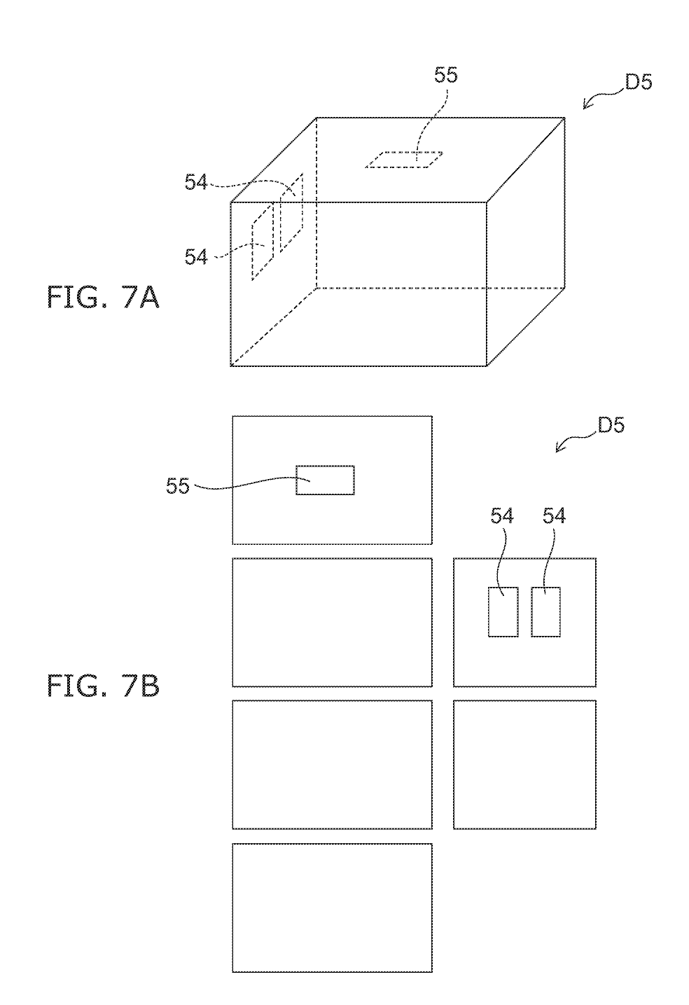

FIG. 7A is a perspective view showing the lighting model; and FIG. 7B is a six-side view.

As shown in FIGS. 6A and 6B, the lighting separation unit 34 extracts the regions of the inner surfaces of the room R of the three-dimensional model D4 for which the luminance is a prescribed threshold or more when imaged at the imaging conditions used as the reference. For example, the lighting separation unit 34 extracts regions 54 corresponding to windows and a region 55 corresponding to a lighting appliance for the room R.

Thereby, as shown in FIGS. 7A and 7B, the lighting regions 54 and 55 are set; and the lighting model D5 that indicates the positions, sizes, and luminance of the lighting regions 54 and 55 is generated. The lighting model D5 is formed from a polygonal model which is a set of triangular meshes and textured images having a wide dynamic range format.

Thus, the three-dimensional model D4 and the lighting model D5 (hereinbelow, also generally called the “target space models”) of the target space are generated.

In the case where multiple rooms R exist in which the furniture F may be placed, the three-dimensional model D4 and the lighting model D5 (the target space models) may be generated, named, and stored for each of the rooms R. For example, the target space models are associated with room names such as “living room,” “dining room,” “study,” etc.; and the target space models are extracted later by using the room names. Also, even for the same target space, target space models may be generated for each of mutually-different multiple environmental conditions. For example, multiple environmental conditions may be set according to the time period of the imaging, the weather when imaging, the open/close state of the curtains, the on/off-state of the lighting, etc.

On the other hand, as shown in step S6 of FIG. 3, the user selects data corresponding to the furniture F from the target object data D2 stored in the target object data storage unit 32 by operating the tablet 10 to access the computer facility 20 of the supplier via the network 30. For example, the user selects the furniture F as the target object by accessing a webpage of the supplier and selecting the furniture F from an electronic catalog published on the webpage. Or, the user selects the furniture F by taking the tablet 10 to the shop of the supplier and reading a product number or a barcode printed in a catalog in the store, on a product tag of the furniture F, etc. Or, the user images the furniture F in the store and specifies the furniture F using image recognition. Thereby, the furniture F is selected as the target object; and the target object data D2 that corresponds to the furniture F is selected.

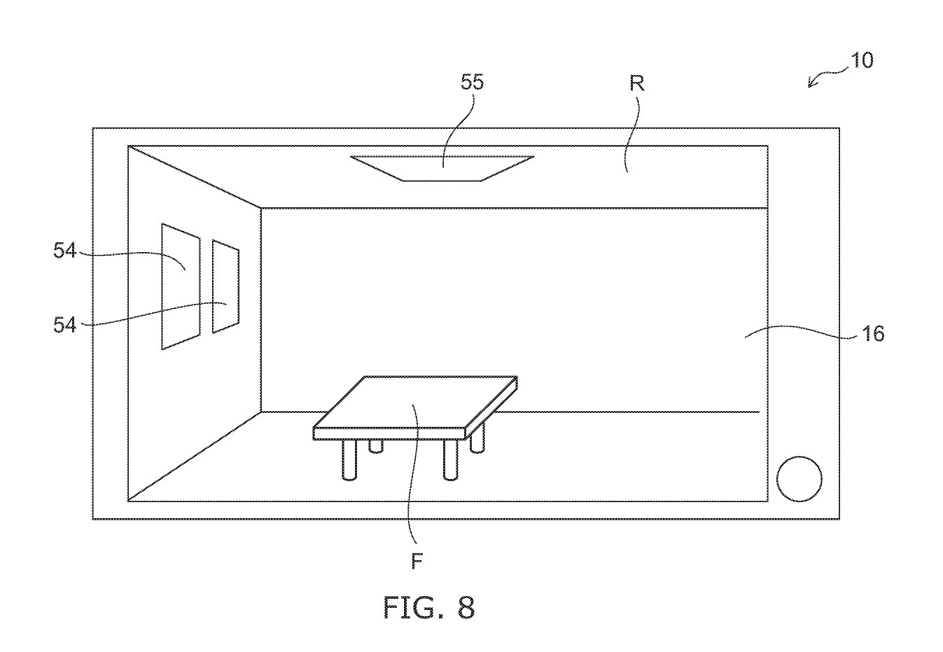

FIG. 8 is an image view showing an image in which the three-dimensional model and the target object data are synthesized.

As shown in FIG. 8 and step S7 of FIG. 3, the user selects the arrangement position of the furniture F by operating the touch panel 14 in the state in which the three-dimensional model D4 of the room R and the target object data D2 of the furniture F are displayed by the display 16 of the tablet 10. For example, in the case where there are multiple rooms R, any room R is selected; and the position and angle at which the furniture F is to be disposed inside the selected room R are selected.

Also, as shown in step S8 of FIG. 3, the user selects the position of the viewpoint in the room R by, for example, operating the touch panel 14 of the tablet 10 while viewing the image shown in FIG. 8. In the case where multiple environmental conditions are set for the same target space when imaging, any of the environmental conditions is selected. Thus, the position of the viewpoint and the position and angle of the furniture F inside the room R are determined by the processing of steps S7 and S8.

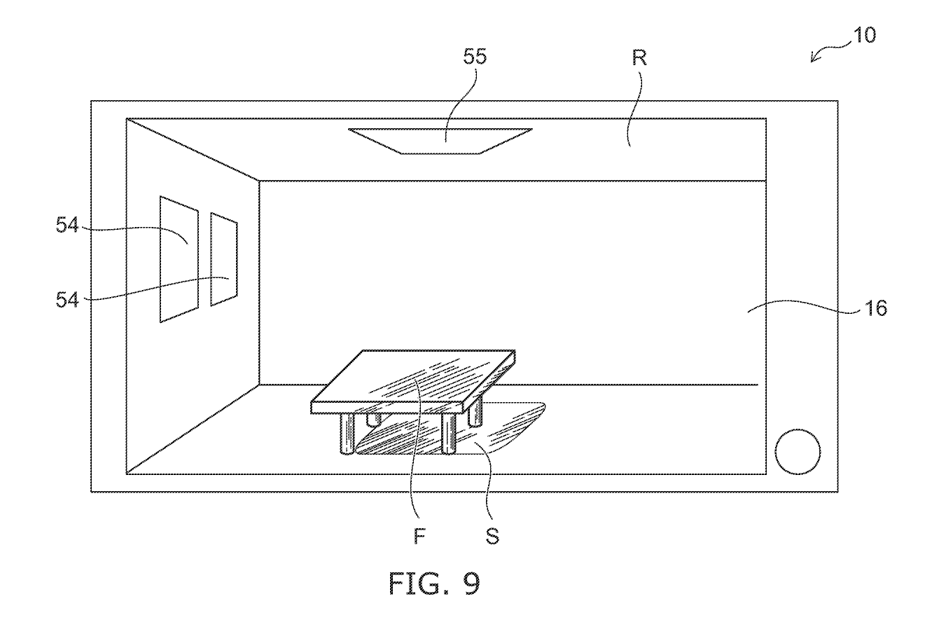

Then, as shown in step S9 of FIG. 3, a rendering unit 35 performs rendering processing of the target object. Specifically, using the target object data D2 and the lighting model D5, the shading of the furniture F as viewed from the viewpoint are simulated by calculating how the light emitted from the lighting regions 54 and 55 is absorbed and reflected to reach the viewpoint after reaching each portion of the furniture F. Thus, shading image D6 of the furniture F is acquired. The shading image D6 is data representing the shading appearing at the target object when assuming the target object to be disposed at any position inside the target space as viewed from any viewpoint inside the target space. The effects of the furniture F on the image of the room R, e.g., the position of shading S (referring to FIG. 9) that the furniture F projects onto the floor of the room R is simulated and reflected in the three-dimensional model D4. At this time, the lighting regions 54 and 55 may be treated as surface light sources or may be approximated as multiple point light sources.

Then, as shown in step S10 of FIG. 3, an image synthesis unit 36 synthesizes an image based on the three-dimensional model D4 of the target space and the shading image D6 of the target object.

FIG. 9 is an image view showing the image in which the shading image and the target object data are synthesized. As shown in FIG. 9, the image synthesis unit 36 synthesizes an image in which the image of the room R represented by the three-dimensional model D4 is used as the background and the image of the furniture F represented by the shading image D6 is used as the foreground. At this time, the information of the shading S is reflected in the three-dimensional model D4. Thereby, synthesized image data D7 is generated.

Then, as shown in step S11 of FIG. 3, the synthesized image is presented based on the synthesized image data D7. For example, the display 16 of the tablet 10 displays the synthesized image. Instead of displaying the synthesized image on the display 16, a signal may be transmitted by wired communication or wireless communication; and the image may be printed using an external printing device or displayed using an external display device.

Thus, the synthesized image that includes the target object virtually disposed in the target space is generated and displayed. The user confirms the scenery of the room R in which the furniture F is disposed by viewing the synthesized image.

Examples of the division of roles between the supplier-side system and the user-side system will now be described.

First, the case will be described where processing belonging to the user-side or supplier-side processing domain B is executed by the user-side system.

In such a case, the target space three-dimensional model generating unit 33, the lighting separation unit 34, the rendering unit 35, and the image synthesis unit 36 are realized by the CPU 12 of the tablet 10. The three-dimensional model D4, the lighting model D5, the shading image D6, and the synthesized image data D7 are stored in the memory 13 of the tablet 10.

In the supplier-side system, the wire frame storage unit 31 and the target object data storage unit 32 are realized in the CPU 22 of the computer facility 20; the wire frame data D1 is stored in the wire frame storage unit 31; and the target object data D2 is stored in the target object data storage unit 32. Also, the user-side system is able to download such data via the network 30.

Then, the supplier provides, to user-side system, a program for causing the calculating unit of the user-side system to execute procedures <1> to <8> recited below as, for example, application software. The user-side system executes procedures <1> to <8> recited below by executing the program. The detailed content of procedures <1> to <8> recited below is as described above.

<1> Provide an interface such that the user can acquire the wire frame data D1 via the network 30.

<2> Provide an interface such that the target space can be imaged to correspond to the wire frame, and acquire the target space image data D3.

<3> Generate the three-dimensional model D4 of the target space based on the wire frame data D1 and the target space image data D3.

<4> Generate the lighting model D5 of the target space by extracting the lighting regions from the three-dimensional model D4.

<5> Provide an interface such that the target object data D2 can be acquired.

<6> Provide an interface such that the user can select the target object, the arrangement position and angle of the target object, and the position of the viewpoint, and generate the shading image D6 based on the target object data D2 and the lighting model D5.

<7> Generate the synthesized image data D7 in which the shading image D6 is used as the foreground and the three-dimensional model D4 is used as the background.

<8> Present a synthesized image to the presentation unit based on the synthesized image data D7.

The case where the processing belonging to the user-side or supplier-side processing domain B is executed by the supplier-side system will now be described.

In such a case, the three-dimensional model generating unit 33, the lighting separation unit 34, the rendering unit 35, and the image synthesis unit 36 are realized by the CPU 22 of the computer facility 20; and the three-dimensional model D4, the lighting model D5, the shading image D6, and the synthesized image data D7 are stored in the HDD 23 of the computer facility 20.

Thereby, the supplier-side system stores the wire frame data D1 and the target object data D2 and executes procedures <3> to <7> recited above. Then, the supplier provides, to the user-side system, a program for causing the calculating unit of the user-side system to execute procedures <1>, <2>, and <8> recited above as, for example, application software. The user downloads the application software described above.

Thereby, the user executes procedures <1> and <2> recited above using the user-side system and transmits the target space image data D3 that is generated to the supplier-side system via the network 30. The supplier-side system that receives the target space image data D3 provided from the user-side system executes procedures <3> to <7> recited above and transmits the synthesized image data D7 that is generated to the user-side system. Then, the user-side system receives the synthesized image data D7 that is provided, executes procedure <8> recited above, and displays the synthesized image.

Effects of the embodiment will now be described.

According to the embodiment, the scenery of the room R in which the furniture F is placed can be simulated without actually transferring into the furniture F to the room R. Thereby, the user can confirm the effects of the furniture F on the interior of the room R beforehand which is helpful to determining whether or not to purchase the furniture F.

Also, according to the embodiment, the lighting model is generated in addition to the three-dimensional model for the room R; and the shading image of the furniture F is generated using the lighting model. Thereby, the appearance of the furniture F can be more realistic because the shading of the furniture F can be simulated according to the arrangement position of the furniture F. In the case where multiple environmental conditions are set, the changes in the appearance of the furniture F in the room R can be confirmed by changing only the environmental conditions while maintaining the same viewpoint position and arrangement position of the furniture F.

Conversely, if the shading image is generated assuming that light from infinity is constantly irradiated on the furniture F, the synthesized image is undesirably quite different from the actual scenery because the way the light is incident on the furniture F does not change even when the arrangement position, the viewpoint position, or the environmental conditions of the furniture F change.

Thus, according to the embodiment, the user may image the target space of a room, etc., of the home and generate the target space models (the three-dimensional model D4 and the lighting model D5) beforehand, find furniture of interest at a furniture shop, use a smartphone, a tablet, etc., at the store to synthesize an image of the furniture with the image of the room of the home, and determine whether or not there is a match with the atmosphere of the home. Once generated, the target space models (the three-dimensional model D4 and the lighting model D5) can be used indefinitely as long as there are no large changes in the target space because the target space models are generated independently from the target object.

Also, when the furniture of interest is found on the website of a mail-order shop on the Internet, the target space model of the room of the home may be uploaded to the mail-order website; the image of the furniture may be synthesized with the image of the room of the home; and it can be determined whether or not there is a match with the atmosphere of the home.

On the other hand, the supplier can promote the purchase by the user of the target object by making it possible for the user to download the application software described above via the website or the like of the supplier and generate the target space model, or by making it possible for the user to transmit the target space image data D3 to the supplier-side system and generate the target space model utilizing the supplier-side system.

In other words, the user that has generated the target space model of the home can confirm the scenery of the furniture of interest when placed in the home to easily make the purchasing decision by reading the target object data D2 of the furniture and generating the synthesized screen described above when the user visits the shop or mail-order website of the supplier. In such a case, if the target space model is stored in the system on the supplier side, there is little burden on the user-side system. Additionally, if the supplier has a shop and a presentation unit is located in the shop, the target space model that is in the possession of the user can be read and the service described above can be provided even in the case where the user did not bring a mobile terminal device.

Various modifications of the embodiment are possible.

For example, although an example is illustrated in the embodiment in which the three-dimensional model D4 is generated from the target space image data D3 representing the captured image and the lighting model D5 is generated by extracting the lighting regions from the three-dimensional model D4, the lighting regions may be extracted from the target space image data D3; and the lighting model D5 may be generated by associating with the three-dimensional model D4.

When generating the lighting model D5 from the three-dimensional model D4, all of the surfaces of the target space may be treated as lighting regions by setting the threshold of the luminance when extracting the lighting regions to be zero. Thereby, for example, the effects of the reflections from the wall surfaces on the shading of the target object can be considered. Conversely, if the threshold is set to be a constant positive value, the lighting regions can be narrowed down; and the calculation amount of the rendering (step S9) can be reduced. Under normal conditions, because the effects of the reflections of the wall surfaces on the shading of the target object are small and the shading substantially is determined by the light directly irradiated on the target object from the windows and the lighting appliances, the calculation amount can be reduced and an effective approximate can be obtained by setting the threshold to a constant value.

Although an example is illustrated in the embodiment in which the image of the three-dimensional model D4 drawn from one viewpoint is used as the background image, this is not limited thereto. For example, the image of the room R that is imaged by the back-surface camera 11 of the tablet 10 may be used as-is as the background image; and the CPU 12 may designate the viewpoint position by estimating the position of the camera 11 and the imaging direction inside the three-dimensional model D4 based on the image and the three-dimensional model D4. Thereby, the user can confirm the shading of the furniture F while actually walking around the room R and successively changing the viewpoint. When changing the look of the room R, the work of changing the look can proceed while confirming the appearance of the furniture F. In the case where two or more pieces of furniture having different tactile properties are already placed inside the room R, the appearance of the furniture is different according to the viewpoint position; but the shading of the furniture F can be confirmed as the background image reflects the different tactile properties due to the viewpoint positions. As a result, the sense of reality that the user receives from the synthesized image improves.

### Second Embodiment

A second embodiment will now be described.

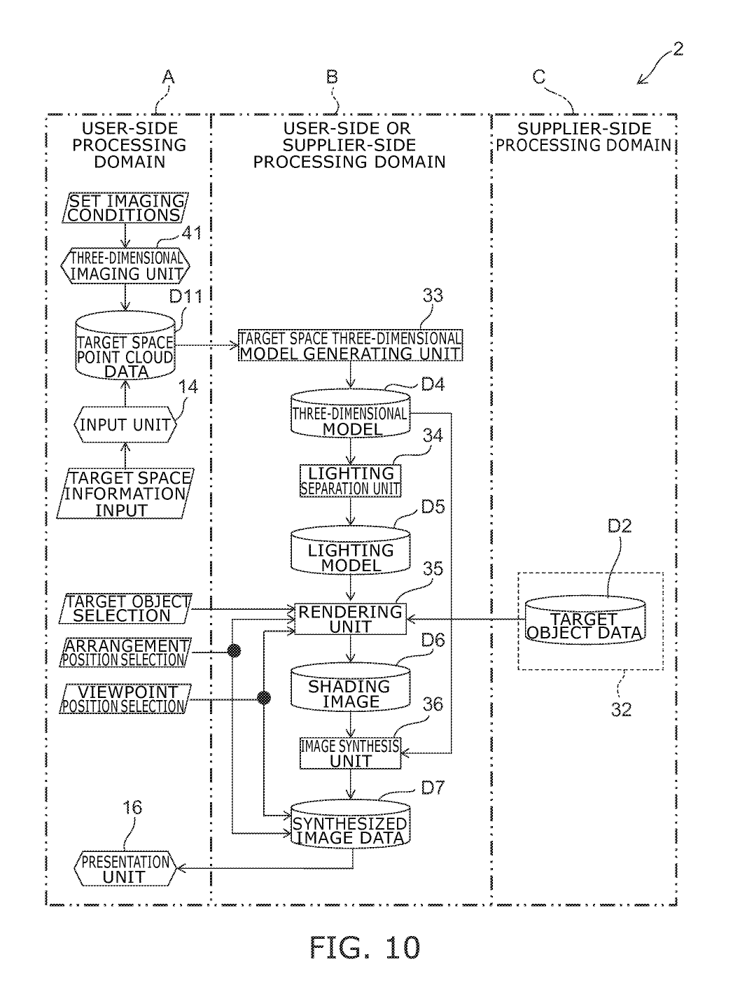

FIG. 10 is a block diagram showing an image generating system according to the embodiment.

As shown in FIG. 10, the image generating system 2 according to the embodiment differs from the image generating system 1 (referring to FIG. 1) according to the first embodiment described above in that a three-dimensional imaging unit 41 is provided instead of the imaging unit 11 (referring to FIG. 1); the wire frame storage unit 31 is not provided; and the wire frame data D1 is not stored.

The three-dimensional imaging unit 41 is a unit, e.g., an RGB-D camera, that can acquire depth information in addition to the color information of the imaging object. The RGB-D camera includes, for example, a depth sensor that utilizes infrared. By the target space being imaged by the three-dimensional imaging unit 41 in the embodiment, point cloud data D11 of the target space including the color information and the depth information is acquired; and the three-dimensional model D4 is generated based on the target space point cloud data D11.

Thereby, an accurate three-dimensional model D4 can be generated because the three-dimensional model D4 can be generated directly from preliminary data without using the wire frame data D1 (referring to FIG. 1). Moreover, the input of the dimensional parameters of the target space, e.g., the width w, the depth d, the height h, etc., shown in FIG. 4A, are unnecessary.

Otherwise, the configuration, the operations, and the effects of the embodiment are similar to those of the first embodiment described above. The three-dimensional imaging unit 41 may be a device in which two or more normal cameras are provided. In such a case, the depth information of the target space is acquired by stereo matching.

### Third Embodiment

A third embodiment will now be described.

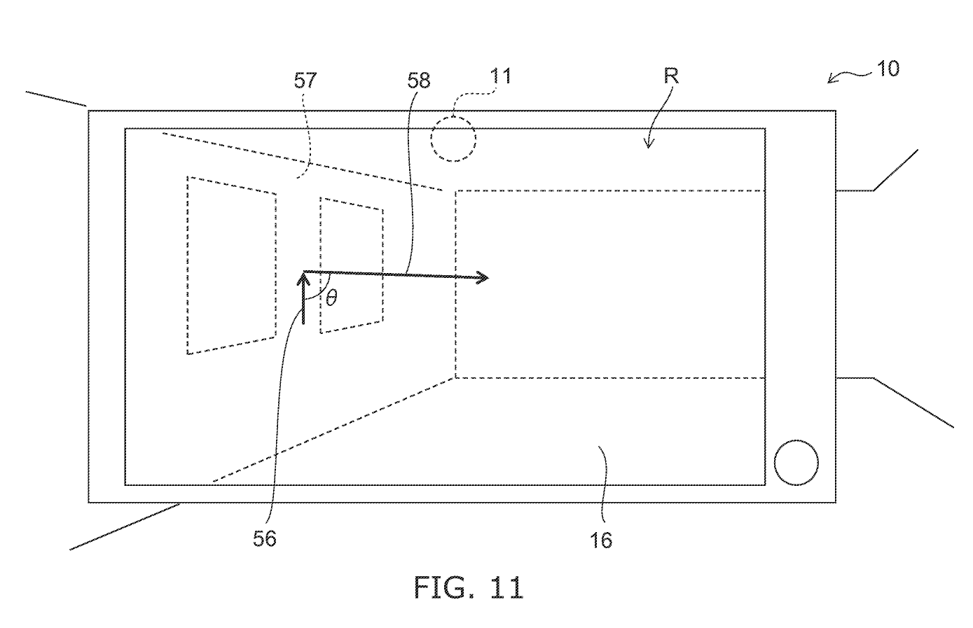

FIG. 11 shows a method for imaging the target space of the embodiment.

In the embodiment as shown in FIG. 11, an angle 8 between an imaging direction 56 of the camera 11 and a normal 58 of a wall surface 57 of the room R is estimated by the imaging process of the target space in step S2 of FIG. 3. Then, the angle θ is input in the information input process of the target space in step S3. Thereby, in the generation process of the lighting model in step S5, the lighting model can be generated by performing a simulation of a light distribution that is closer to the actual light distribution for lighting that has different light distributions according to the viewing direction.

Otherwise, the configuration, the operations, and the effects of the embodiment are similar to those of the first embodiment described above.

### Fourth Embodiment

A fourth embodiment will now be described.

In the embodiment, in the rendering process in step S9 of FIG. 3, the rendering is performed by considering only a portion of the lighting regions included in the lighting model D5. For example, in the case where the target space is a wide space, e.g., a long corridor, a wide floor, etc., of a large building, the rendering is performed by considering only the lighting regions proximal to the target object. Thereby, the calculation amount necessary for the rendering processing can be reduced.

In the synthesis process of the image of step S10, the image may be synthesized by reading only a portion of the data of the three-dimensional model D4. For example, in the case where the target space is a wide space, background images having high resolution may be generated for the regions proximal to the viewpoint position and the target object; and background images having low resolution may be generated for the regions distal to the viewpoint position and the target object. Thereby, the calculation amount of the synthesis and presentation of the image can be reduced.

Otherwise, the configuration, the operations, and the effects of the embodiment are similar to those of the first embodiment described above.

### Fifth Embodiment

A fifth embodiment will now be described.

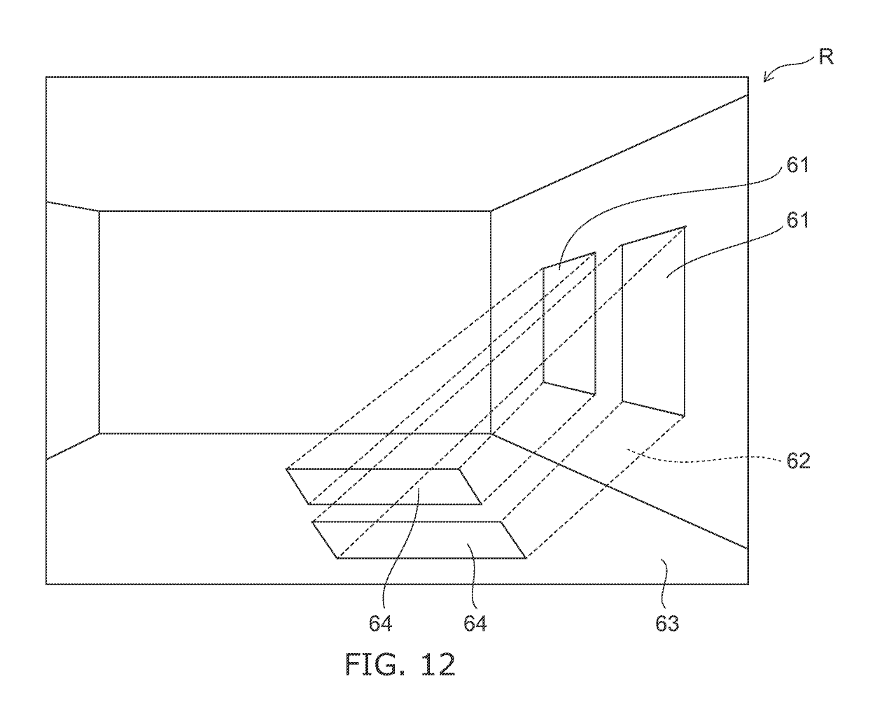

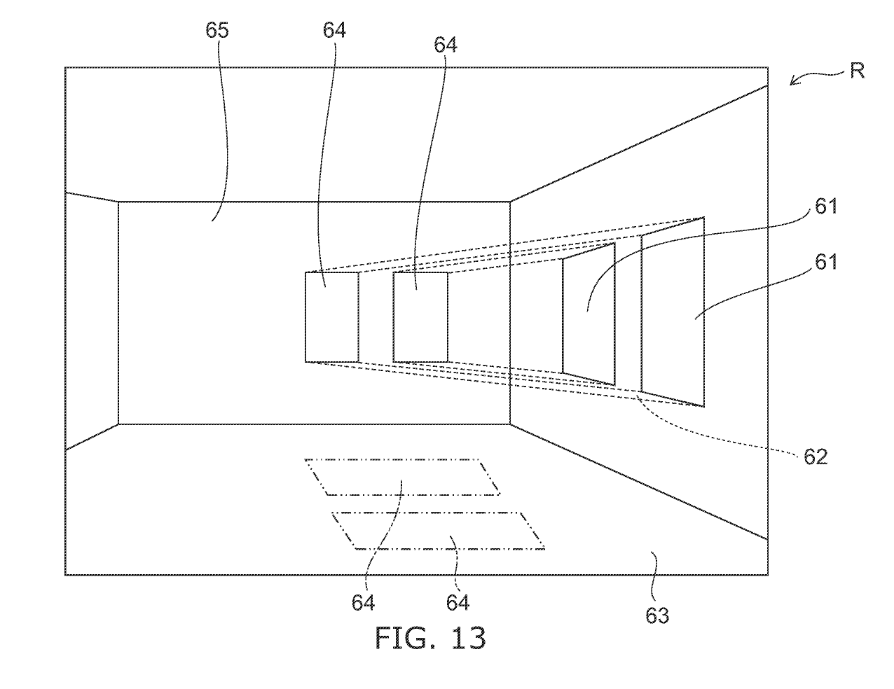

FIG. 12 and FIG. 13 show the target space of the embodiment.

In the case where sunlight 62 shines through windows 61 of the room R as shown in FIG. 12, because the sunlight 62 is parallel light, there are cases where sunny spots 64 that are formed on a floor surface 63 appear to be brighter than the windows 61 due to the imaging position. In such a case, in the process of generating the lighting model D5 in step S5 of FIG. 3, the windows 61 may not be extracted as lighting regions; and the sunny spots 64 may undesirably be extracted as lighting regions. Thereby, it is difficult to accurately simulate shading.

Therefore, in the embodiment, the attributes of the lighting are input in the process of inputting the information of the target space in step S3 of FIG. 3. For example, in the image of the room R that is imaged, the regions corresponding to the windows 61 and the regions corresponding to the sunny spots 64 are designated; and it is input that the parallel light enters from the windows 61. Thereby, in the process of generating the lighting model D5 of step S5, the lighting separation unit 34 can calculate the direction of the sunlight 62 from the windows 61 toward the sunny spots 64 and estimate the luminous intensity of the sunlight 62 based on the reflectance of the floor surface 63 and the luminance of the sunny spots 64. Such estimating may be performed in the generation process of the three-dimensional model in step S4. As a result, in the rendering process of step S9, accurate shading image D6 can be generated by considering the sunlight 62.

The direction of the sunlight 62 and the positions of the sunny spots 64 change with time and date. For example, although the sunny spots 64 are formed on the floor surface 63 at one time and date as shown in FIG. 12, the sunny spots 64 are formed on a wall surface 65 at another time and date as shown in FIG. 13. However, the lighting model can be estimated at any time and date from the lighting model based on the actual captured image, the time and date of the imaging, and the position and direction in the room R because the direction of the sunlight 62 can be predicted accurately based on the position and direction in the target space and the time and date. In such a case, in the three-dimensional model D4, the luminance value of the regions where the sunny spots 64 were positioned is replaced with the luminance values of proximal regions. In other words, the former sunny spots 64 are redrawn with images of the proximal regions. On the other hand, images that model the sunny spots 64 are newly generated in the regions where the sunny spots 64 are predicted to be positioned.

According to the embodiment, directly-incident sunlight can be treated appropriately; and a synthesized image that is closer to actual conditions can be generated. Otherwise, the configuration, the operations, and the effects of the embodiment are similar to those of the first embodiment described above.

According to the embodiments described above, an image generating system and an image generating program that can accurately predict the shading of the target object can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Additionally, the embodiments described above can be combined mutually.

What is claimed is:

1. An image generating system configured to generate an image of a target object virtually disposed inside a target space, the system comprising:
a storage unit configured to store target object data representing a three-dimensional configuration of the target object and an external appearance of the target object;
a calculating unit configured to generate a three-dimensional model of the target space, generate a lighting model indicating a lighting region of the target space, generate a shading image based on the target object data and the lighting model, and generate a synthesized image of the shading image and the three-dimensional model, the shading image representing shading appearing at the target object, the shading image being performed by a selection of the target object, an arrangement position of the target object, and a position of a viewpoint; and
a presentation unit configured to present the synthesized image.

2. The system according to claim 1, further comprising an imaging unit configured to acquire image data of the target space,
the storage unit being configured to store wire frame data representing a configuration of the target space,
the calculating unit being configured to generate the three-dimensional model based on the wire frame data and the image data and separate the lighting region from the three-dimensional model.

3. The system according to claim 2, wherein the calculating unit is configured to synthesize the synthesized image from the image data and the shading image.

4. The system according to claim 2, wherein the calculating unit is configured to separate the lighting region from the three-dimensional model by extracting a region where a luminance of an inner surface of the three-dimensional model is not less than a reference value.

5. The system according to claim 2, further comprising an input unit configured to input a dimension of the target space to the storage unit.

6. The system according to claim 2, wherein the imaging unit and the presentation unit are mounted in a mobile terminal device.

7. The system according to claim 1, further comprising a three-dimensional imaging unit configured to acquire color information and depth information of the target space,
the calculating unit being configured to generate the three-dimensional model based on the color information and the depth information.

8. The system according to claim 2, wherein the calculating unit is configured to generate the lighting model based on an angle between an imaging direction of the imaging unit and a normal of an imaging surface of the target space.

9. The system according to claim 1, wherein the calculating unit is configured to generate the shading image by considering only a portion of the lighting region included in the lighting model.

10. The system according to claim 1, wherein the calculating unit is configured to estimate a direction of parallel light entering from a window and generate the shading image by considering the parallel light when a region corresponding to the window of the three-dimensional model and a region corresponding to a sunny spot of the three-dimensional model are designated.

11. An image generating system configured to generate an image of a target object virtually disposed inside a target space, the system comprising:
a storage unit configured to store target object data representing a three-dimensional configuration of the target object and an external appearance of the target object; and
a calculating unit configured to generate a three-dimensional model of the target space, generate a lighting model indicating a lighting region of the target space, generate a shading image based on the target object data and the lighting model, and generate a synthesized image of the shading image and the three-dimensional model, the shading image representing shading appearing at the target object, the generating of the shading image being performed by a selection of the target object, an arrangement position of the target object, and a position of a viewpoint.

12. The system according to claim 11, wherein
the storage unit is configured to store wire frame data representing a configuration of the target space, and
the calculating unit is configured to generate the three-dimensional model based on the wire frame data and image data of the target space and generate the lighting region by extracting a region where a luminance of an inner surface of the three-dimensional model is not less than a reference value.

13. An image generating program product comprising a computer-readable medium containing a computer program that causes a computer to execute:
generating a three-dimensional model of the target space and generating a lighting model indicating a lighting region of the target space;
generating a shading image based on the lighting model and target object data, the shading image representing shading appearing at the target object, the target object data representing a three-dimensional configuration of the target object and an external appearance of the target object, the generating of the shading image being performed by a selection of the target object, an arrangement position of the target object, and a position of a viewpoint; and
generating a synthesized image of the shading image and the three-dimensional model.

14. The product according to claim 13, wherein the program, further causes the computer to execute:
acquiring image data of the target space;
generating the three-dimensional model based on the image data and wire frame data, the wire frame data representing a configuration of the target space; and
separating the lighting region from the three-dimensional model.

15. The product according to claim 14, wherein the calculating unit is caused, in the procedure of separating the lighting region, to execute a procedure of extracting a region where a luminance of an inner surface of the three-dimensional model is not less than a reference value.

16. An image generating system configured to generate an image of a target object virtually disposed inside a target space, the system comprising:
a calculating unit configured to generate a three-dimensional model of the target space, generate a lighting model indicating a lighting region of the target space, acquire target object data representing a three-dimensional configuration of the target object and an external appearance of the target object, generate a shading image based on the target object data and the lighting model, and generate a synthesized image of the shading image and the three-dimensional model, the shading image representing shading appearing at the target object, the shading image being performed by a selection of the target object, an arrangement position of the target object, and a position of a viewpoint; and
a presentation unit configured to present the synthesized image.

17. The system according to claim 16, further comprising an imaging unit configured to acquire image data of the target space,
the calculating unit being configured to acquire wire frame data representing a configuration of the target space, generate the three-dimensional model based on the wire frame data and the image data, and separate the lighting region from the three-dimensional model.

18. The system according to claim 17, wherein the imaging unit and the presentation unit are mounted in a mobile terminal device.

19. The system according to claim 17, further comprising an input unit for inputting a dimension of the target space.

20. The system according to claim 16, further comprising a three-dimensional imaging unit for acquiring color information and depth information of the target space,
the calculating unit being configured to generate the three-dimensional model based on the color information and the depth information.
